(19) United States
(12) Patent Application Publication
(10) Pub. No.: US 2008/0088872 A1
(43) Pub. Date: Apr. 17, 2008

(54) Communication System, Communication Method, and Communication Terminal Device

(75) Inventor: Osamu Kimoto, Kyoto-shi (JP)

Correspondence Address: HOGAN & HARTSON L.L.P., 1999 AVENUE OF THE STARS, SUITE 1400, LOS ANGELES, CA, 90067, US

(73) Assignee: MURATA MACHINERY, LTD., Kyoto-shi (JP)

(21) Appl. No.: 11/871,883

(22) Filed: Oct. 12, 2007

(30) Foreign Application Priority Data
Oct. 16, 2006 (JP) 2006-281244

(51) Int. Cl. H04N 1/00

(52) U.S. Cl. 358/1.15

(57) ABSTRACT

A communication method performed between a transmission side device which cannot execute a communication function of an ITU-T recommendation V.34 communication mode and a reception side device which can execute the communication function of the ITU-T recommendation V.34 communication mode. The reception side device receives a calling signal indicating a request for communication from the transmission side device. The reception side device sends an ANSam signal to the transmission side device. The reception side device measures a time a silent state continues after sending the ANSam signal. The reception side device sends a DIS signal to the transmission side device when the measured time exceeds a predetermined time.

### CROSS-REFERENCE TO RELATED APPLICATIONS

This application claims priority under 35 U.S.C. 119 to Japanese Patent Application No. 2006-281244, filed on Oct. 16, 2006, which application is hereby incorporated by reference in its entirety.

### BACKGROUND OF THE INVENTION

1. Field of the Invention

The present invention relates to a technique of suppressing communication errors in a communication between a communication terminal device having a communication function of the International Telecommunications Union-Telecommunication standardization sector (ITU-T) recommendation V.34 communication mode and a communication terminal device not having a communication function of the ITU-T recommendation V.34 communication mode.

2. Description of the Related Art

In communication terminal devices such as facsimile machines, a so-called Group 3 (G3) machine that complies with the ITU-T recommendation V.29 (maximum communication speed: 9,600 bps) communication mode has conventionally been put to practical use. In recent years, a so-called Super G3 (SG3) machine that complies with the V.34 (maximum communication speed: 33.6 kbps) communication mode of increased maximum communication speed and that also responds to V.29 communication mode has been proposed.

In such a SG3 machine, a start-up procedure by the ITU-T recommendation V.8 is performed before starting the procedures of V.34. The SG3 machine sends a Modified answer tone (ANSam) signal, which is a phase inverted signal of 2,100 Hz, in time of incoming call. The ANSam signal itself is a signal defined in V.8. If the communication function of the V.34 communication mode is turned OFF, the transmission side device cannot detect the ANSam signal, and thus cannot respond to the ANSam signal even if the transmission side device is a G3 or SG3 machine. In this case, the SG3 machine or a reception side device stops sending the ANSam signal and sends a Digital Identification Signal (DIS), which is a procedure signal of the G3 machine. The transmission side device responds to such DIS, whereby the communication between the relevant devices is continuously executed.

When executing the communication through an Internet Protocol (IP) networks an echo canceller function might turn OFF (disabled state) when a gateway detects the ANSam signal used in the V.34 communication mode since a full duplex method is adopted in the V.34 communication mode. If communication of lower than or equal to the V.29 (maximum communication speed: 9,600 kbps) communication mode is performed with the echo canceller function turned OFF, a termination flag of a Frequency Shift Keying (FSK) signal sent from the reception side device may be mistakenly recognized as a FSK signal sent from the transmission side device in the procedure of high-low speed identification of the reception side device. Due to such mistaken recognition, the reception side device will be in the low-speed stand-by state, and thus cannot receive an original high-speed image signal when such signal comes in, whereby time-out of FSK signal standby occurs and communication errors occur. Thus, communication errors tend to easily occur when switching from the FSK signal to the high speed image signal.

The echo canceller function that is once turned OFF can be returned to the ON state (enabled state) by creating a silent state of 250 ms±150 ms. Therefore, a communication terminal device having the ITU-T recommendation V.34 communication mode is proposed, which when detecting the DIS after detecting the ANSam from the reception side device in time of issuing a call, does not respond to the relevant DIS, but detects the next DIS and sends a predetermined response signal, specifically, Digital Command signal (DCS).

### BRIEF SUMMARY OF THE INVENTION

In the prior art, the transmission side device does not respond to the DIS detected after detecting the ANSam signal from the reception side device, but sends the DCS with respect to the next DIS. The silent time is thereby created on a communication line, and the echo canceller function can be returned to the ON state.

However, the transmission side device sometimes sends a call Menu (CM) signal, which is a predetermined response signal with respect to the ANSam signal, with a delay with respect to the relevant ANSam signal from the reception side device. In this case, the delayed CM signal will exist on the IP network even if waiting for a predetermined time in the reception side device, and a silent state sufficient for the echo canceller function to return to the enabled state cannot be created. Therefore, when the echo canceller function is turned OFF, the communication is executed in such state, and communication errors may occur.

It is an object of the present invention to provide a technique capable of executing the communication without producing communication errors even if the response signal with respect to the ANSam signal is sent with a delay.

A first aspect of the present invention relates to a communication system for performing a communication between a transmission side device which cannot implement a communication function of an ITU-T recommendation V.34 communication mode and a reception side device which can implement the communication function of the ITU-T recommendation V.34 communication mode. The reception side device includes a communication unit for transmitting and receiving a signal, and a control unit for controlling the communication unit. When the communication unit receives a calling signal indicating the transmission side device is requesting communication with the reception side device, the control unit sends an ANSam signal to the transmission side device from the communication unit. Then, the control unit sends a DIS signal to the transmission side device from the communication unit after a silent state from termination of sending the ANSam signal continues for a predetermined time on a communication line with the transmission side device.

A second aspect of the present invention relates to a communication method performed between a transmission side device which cannot implement a communication function of an ITU-T recommendation V.34 communication mode and a reception side device which can implement the communication function of the ITU-T recommendation V.34 communication mode. The method includes a step in which the reception side device receives a calling signal indicating a request for communication from the transmission side device; a step in which the reception side device sends an ANSam signal after the first step; a step in which the reception side device measures a time a silent state continues; and a step in which the reception side device sends a DIS signal when the measured time exceeds a predetermined time.

A third aspect relates to a communication terminal device which can implement a communication function of an ITU-T recommendation V.34 communication mode. The communication terminal device includes a communication unit for transmitting and receiving a signal; and a control unit for controlling the communication unit. When the communication unit receives a calling signal, the control unit sends an ANSam signal from the communication unit. The control unit then sends a DIS signal from the communication unit after a silent state from termination of sending the ANSam signal continues for a predetermined time on a communication line.

According to such aspects, when a silent state continues for a predetermined time in a communication line with the transmission side device, the reception side device sends the DIS, thereby reliably returning the echo canceller function to the enabled state. Therefore, the communication can be executed without producing communication errors.

Other features, elements, processes, steps, characteristics and advantages of the present invention will become more apparent from the following detailed description of embodiments of the present invention with reference to the attached drawings.

### BRIEF DESCRIPTION OF THE DRAWINGS

FIG. 1 is a block diagram of a communication system according to an embodiment of the present invention;

FIG. 2 is a flowchart illustrating operations of a control unit according to an embodiment of the invention; and

FIG. 3 is a flowchart illustrating operations in a communication system according to an embodiment of the present invention.

### DETAILED DESCRIPTION OF EMBODIMENTS OF THE INVENTION

A communication system and method by a facsimile device are now described based on the drawings as one example of a communication system, method and device according to an embodiment of the present invention.

<Configuration of Device>

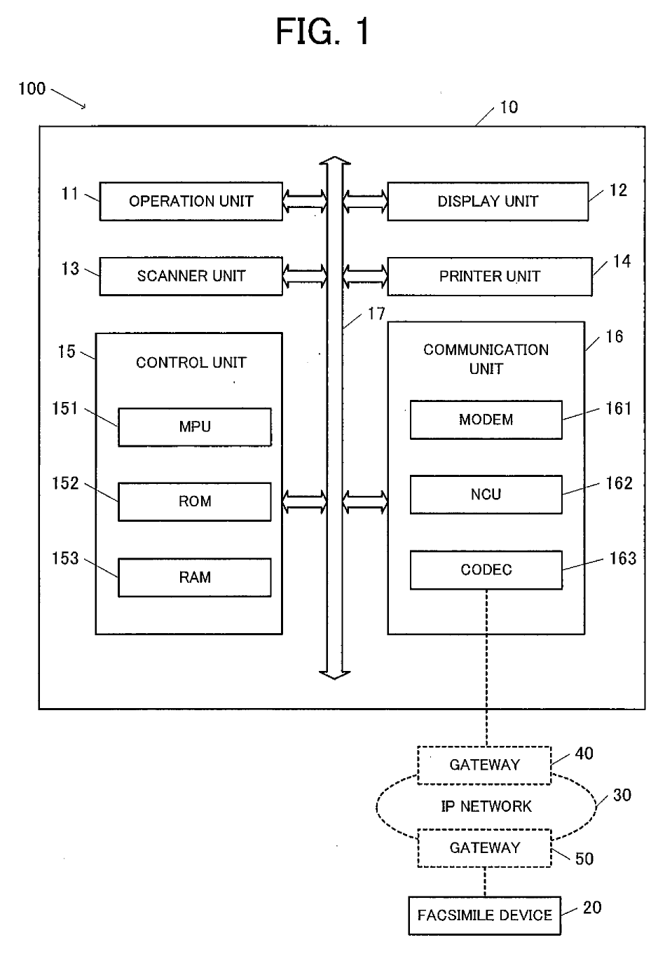

FIG. 1 is a block diagram of a communication system 100 according to an embodiment of the present invention.

A facsimile device 10 corresponds to a reception side device in a communication system and method of the present invention, and includes an operation unit 11, a display unit 12, a scanner unit 13, a printer unit 14, a control unit 15, and a communication unit 16, which units are connected to each other by way of a bus 17. The facsimile device 10 has a facsimile function of transmitting and receiving image data with another facsimile device 20 at a remote location by way of an IP (Internet Protocol) network 30, and gateways 40, 50. The facsimile device 20 corresponds to the reception side device in the communication system and method of the present invention.

The operation unit 11 is configured by a mechanical switch, and accepts operations from a user such as outgoing correspondence and data input, execution instructions of various commands, and the like. The display unit 12 is configured by a display device such as Liquid Crystal Display (LCD), and displays various information. A touch screen may be applied to the display unit 12 to also be provided with the function of a part of or all of the operation unit 11. The scanner unit 13 optically scans a transmitting document by Charged Coupled Device (CCD), and the like, and generates image data. The printer unit 14 includes an image memory (not illustrated) for storing image data, and prints the image data stored in the image memory on a recording paper placed in a recording paper cassette (not illustrated).

The control unit 15 includes a Micro Processing Unit (MPU) 151, a Read Only Memory (ROM) 152, and a Random Access Memory (RAM) 153. The MPU 151 realizes each function of the facsimile device 10 by performing control of an input signal from the operation unit 11, data computation based on the input signal and generation of an output signal, and display of content on the display unit 12. The ROM 152 is stored with data necessary for program and control executed by the MPU 151, and the RAM 153 temporarily stores data necessary for integrated control by the MPU 151. Various functions of the facsimile device 10 are thereby realized. The function for the control unit 15 to control each component will be described later in detail.

The communication unit 16 includes a Modulator-Demodulator (MODEM) 161 having a communication function of the ITU-T recommendation V.34 communication mode, a Network Control Unit (NCU) 162, and a Coder-decoder (CODEC) 163. The communication unit 16 performs transmission and reception of data with the other facsimile device 20 connected by way of gateways 40, 50, which are connected to the IP network 30, by control from the MPU 151. The facsimile device 10 is a SG3 machine having a communication function of the ITU-T recommendation V.34 communication mode, and is assumed to also have the facsimile communication function of the conventional G3 method and the like. The IP network 30 is connected not only to the gateways 40, 50, but is also connected to other gateways, whereby the facsimile device 10 is communicable with other facsimile devices although the illustration thereof is omitted.

In the present embodiment, the facsimile device 20 is assumed to be a G3 machine that cannot execute the communication function of the ITU-T recommendation V.34 communication mode.

<Detailed Function of Control Unit>

The control unit 15 sends an ANSam signal to the facsimile device 20 from the communication unit 16 when a calling tone (CNG) signal indicating that the facsimile device 20 is requesting communication with the facsimile device 10 is received by the communication unit 16. After the silent state from the termination of sending the ANSam signal continues for a predetermined time in the communication line with the facsimile device 20, the DIS is sent from the communication unit 16 to the facsimile device 20.

Specifically, when the CNG signal from the facsimile device 20 is received via the IP network 30 and the gateways 40, 50, the control unit 15 performs a control to send the ANSam signal from the communication unit 16. Then, the control unit 15 sends the DIS to the facsimile device 20 from the communication unit 16 after the silent state from the termination of sending the ANSam signal is continued for a predetermined time in the communication line with the facsimile device 20. The predetermined time of the silent state to be continued is desirably greater than or equal to 400 ms, and more desirably less than or equal to 500 ms.

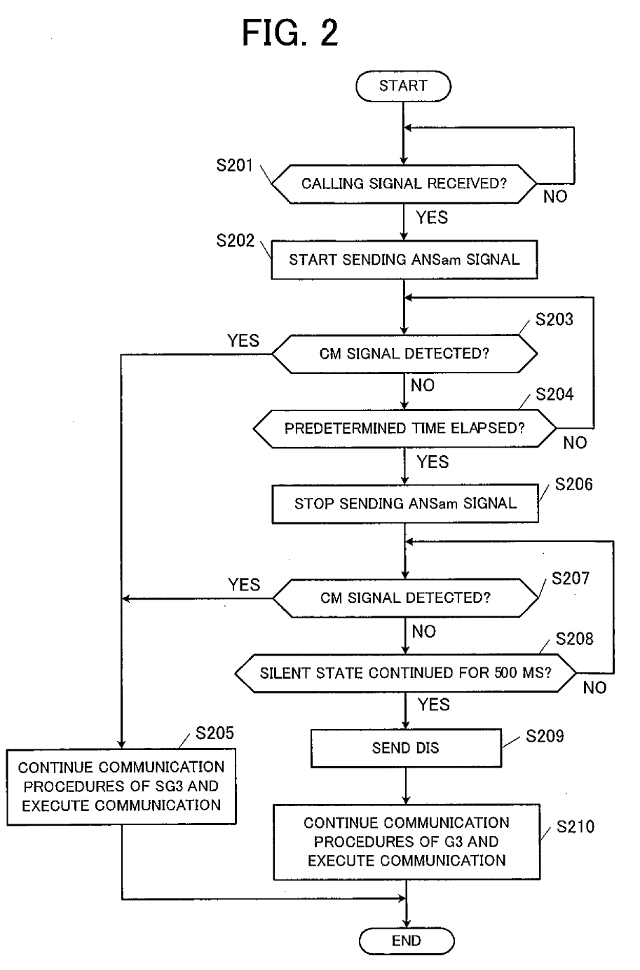

FIG. 2 is a flowchart illustrating operations of the control unit 15. First, the control unit 15 waits until the communication unit 16 receives the CNG signal indicating that the facsimile device 20 is requesting communication with the facsimile device 10 (step S201). When the CNG signal is received, Yes is selected in step S201, and the control unit 15 performs a control to start sending the ANSam signal to the facsimile device 20 from the communication unit 16 (step S202).

The control unit 15 starts sending the ANSam signal in step S202, and at the same time, determines whether or not an enabled signal, specifically, the CM signal from the facsimile device 20 is detected (step S203), and determines whether or not a predetermined time for sending the ANSam signal has elapsed (step S204).

If the facsimile device 20 can implement the communication function of the V.34 communication mode, the facsimile device 20, which is assumed to be the transmission side device, sends the CM signal with respect to the ANSam signal from the facsimile device 10. Therefore, the control unit 15 detects the CM signal in step S203, and continues the communication procedure of SG3 and executes the communication (step S205)

If the facsimile device 20 cannot implement the communication function of the V.34 communication mode, the ANSam signal cannot be detected. Therefore, the CM signal is not detected in step S203. After a predetermined time for sending the ANSam signal has elapsed, the control unit 15 stops sending the ANSam signal (step S206).

The control unit 15 then detects whether or not a signal energy, specifically, the CM signal is present in the communication line between the facsimile device 10 and the facsimile device 20, where if the CM signal is present, YES is selected in step S207, and the process of step S205 is executed. This is the process when the response of the CM signal with respect to the ANSam signal is delayed although the facsimile device 20 can implement the communication function of the V.34 communication mode.

Thereafter, the control unit 15 determines whether or not the silent state from the termination of sending the ANSam signal has continued for at least 250 ms±150 ms, specifically, 500 ms (step S208). If the silent state continued for 500 ms, YES is selected in step S208, and the control unit 15 sends the DIS to the facsimile device 20 from the communication unit 16 (step S209). Thereafter, the control unit 15 continues the communication procedures of the G3 and executes the communication (step S210).

<Communication System 100>

A communication system 100 applied with the facsimile device 10 and the facsimile device 20 will now be described.

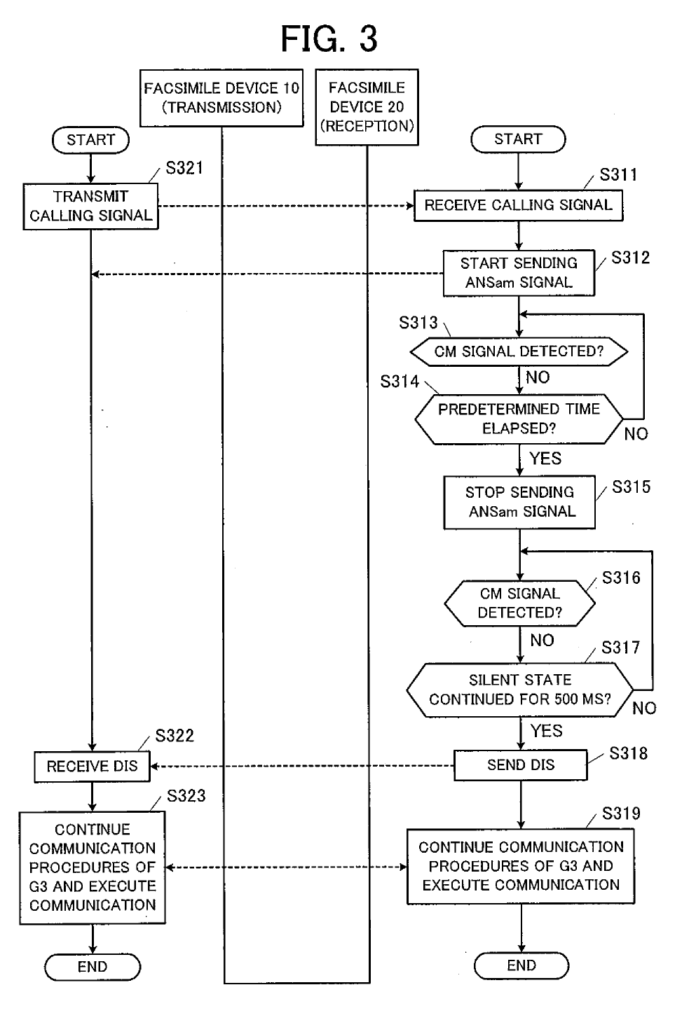

FIG. 3 is a flowchart illustrating processing operations in the communication system 100 of the present invention. In this flowchart, a flowchart (steps S311-S319) for the processing operations of the facsimile device 10 and a flowchart (steps S321-S323) for the operations of the facsimile device 20 are shown in association with each other.

Only the operation for returning the echo canceller function to the ON state is shown in FIG. 3, and illustration and description of other operations are omitted. Unless specifically described, a series of operations (steps S311-S319) in the facsimile device 10 are automatically performed under the control of the control unit 15, and a series of operations (steps S321-S323) in the facsimile device 20 are automatically performed under a control unit (not illustrated) of the facsimile device 20.

When the user of the facsimile device 20 inputs a telephone number of the facsimile device 10, the facsimile device 20 transmits the CNG signal indicating a request for communication with the facsimile device 10 (step S321). In response thereto, the facsimile device 10 receives the CNG signal (step S311).

When receiving the CNG signal from the facsimile device 20 in step S311, the control unit 15 of the facsimile device 10 starts sending the ANSam signal to the facsimile device 20 (step S312).

The control unit 15 starts sending the ANSam signal in step S312, and at the same time, determines whether or not the CM signal from the facsimile device 20 has been detected (step S313), and determines whether or not a predetermined time for sending the ANSam signal has elapsed (step S314). In the present embodiment, the facsimile device 20 is a G3 machine, and thus the facsimile device 20 cannot detect the ANSam signal. Therefore, the facsimile device 20 does not send the CM signal, and the facsimile device 10 does not detect the CM signal. No is thus selected in step S313.

When Yes is selected in step S314 (i.e., predetermined time for sending the ANSam signal has elapsed), the control unit 15 stops sending the ANSam signal (step S315).

The control unit 15 then detects whether or not the CM signal is present on the communication line between the facsimile devices 10, 20 (step S316). Since the facsimile device 20 does not send the CM signal, No is selected in step S316.

The control unit 15 then determines whether or not the silent state from the termination of sending the ANSam signal has continued for at least 250 ms±150 ms, specifically, 500 ms (step S317). If the silent state continued for 500 ms, YES is selected in step S317, and the control unit 15 sends the DIS to the facsimile device 20 from the communication unit 16 (step S318).

When the DIS sent in step S318 is received by the facsimile device 20 (step S322), the facsimile devices 10, 20 respectively continue the communication procedures of G3 and execute the communication (step S319, S323), and then terminate the communication.

Therefore, since the DIS is sent when the silent state continues for a predetermined time in the communication line with the facsimile device 20, the silent state is reliably obtained for a predetermined time in the communication line after the ANSam signal is sent. Therefore, even if the gateways 40, 50 having a function of disabling the echo canceller function are present on the network, for example, the echo canceller function disabled by the ANSam signal is reliably returned to the enabled state. In particular, the echo canceller function is reliably returned to the enabled state even if the CM signal is sent with a delay with respect to the ANSam signal from the facsimile device 20 or the transmission side device. Therefore, communication can be executed without producing communication errors.

Since the DIS is sent after the silent state continues for greater than or equal to 400 ms, the echo canceller function is reliably returned to the enabled state.

Furthermore, since the sending of the DIS is not delayed by longer than 500 ms, the communication does not need to be stopped more than necessary, and communication can be rapidly executed.

Moreover, since the DIS signal is sent after the silent state has continued for a predetermined time in the communication line between the facsimile device 20 and the facsimile device 10, the echo canceller function is reliably returned to the enabled state. Therefore, communication is executed without producing communication errors.

<Variant>

An embodiment of the present invention has been described, but the present invention is not limited to the content described above.

For instance, the facsimile device 20 is a G3 machine that can not implement the communication function of the ITU-T recommendation V.34 communication mode in the above embodiment, but may be a facsimile device provided with a function serving as the G3 machine and a function serving as the SG3 machine so as to be able to select either function. In this case, if the function serving as the SG3 machine is selected, the communication is executed in the communication procedures of the SG3, and if the function serving as the G3 machine is selected, the communication is executed in the communication procedures of G3 according to the method described above.

The facsimile device 10, which is the communication terminal device, of the above described embodiment is a device capable of transmitting and receiving image data, but may be a communication terminal device capable of only receiving the image data, or may be a multifunctional peripheral (MFP) having a plurality of functions such as a scan function and a print function in addition to the facsimile function.

While the present invention has been described with respect to preferred embodiments thereof, it will be apparent to those skilled in the art that the disclosed invention may be modified in numerous ways and may assume many embodiments other than those specifically set out and described above. Accordingly, it is intended by the appended claims to cover all modifications of the present invention that fall within the true spirit and scope of the present invention.

What is claimed is:

1. A communication system comprising:
a transmission side device not executing a communication function of an ITU-T recommendation V.34 communication mode;
a reception side device executing the communication function of the ITU-T recommendation V.34 communication mode; wherein
the reception side device is configured by,
a communication unit for transmitting and receiving a signal; and
a control unit for controlling the communication unit; wherein
when the communication unit receives a calling signal indicating the transmission side device is requesting communication with the reception side device, the control unit sends an ANSam signal to the transmission side device from the communication unit and sends a DIS signal to the transmission side device from the communication unit after a silent state from termination of sending the ANSam signal continues for a predetermined time on a communication line with the transmission side device.

2. The communication system according to claim 1, further comprising:
gateways interposed between the transmission side device and the reception side device; and
an echo canceller arranged in the gateway and turned ON through continuation of the silent state.

3. The communication system according to claim 1, wherein the predetermined time is not less than 400 ms.

4. The communication system according to claim 3, wherein the predetermined time is not more than 500 ms.

5. The communication system according to claim 1, wherein the reception side device is a SG3 machine and the transmission side device is a G3 machine.

6. A communication method performed between a transmission side device not executing a communication function of an ITU-T recommendation V.34 communication mode and a reception side device executing the communication function of the ITU-T recommendation V.34 communication mode; the method comprising:
a step in which the reception side device receives a calling signal indicating request for communication from the transmission side device;
a step in which the reception side device sends an ANSam signal to the transmission side device;
a step in which the reception side device measures a time a silent state continues after sending the ANSam signal; and
a step in which the reception side device sends a DIS signal to the transmission side device when the measured time exceeds a predetermined time.

7. The communication method according to claim 6, further comprising:
a step in which a gateway detects the ANSam signal and turns OFF an echo canceller; and
a step of turning ON the echo canceller when the gateway detects continuation of the silent state after detecting the ANSam signal.

8. The communication method according to claim 6, wherein the predetermined time is not less than 400 ms.

9. The communication method according to claim 8, wherein the predetermined time is not more than 500 ms.

10. The communication method according to claim 6, wherein the reception side device is a SG3 machine and the transmission side device is a G3 machine.

11. A communication terminal device executing a communication function of an ITU-T recommendation V.34 communication mode; the communication terminal device comprising:
a communication unit for transmitting and receiving a signal; and
a control unit for controlling the communication unit: wherein
when the communication unit receives a calling signal, the control unit sends an ANSam signal from the communication unit and sends a DIS signal from the communication unit after a silent state from termination of sending the ANSam signal continues for a predetermined time on a communication line.

12. The communication terminal device according to claim 11, wherein the predetermined time is not less than 400 ms.

13. The communication terminal device according to claim 12, wherein the predetermined time is not more than 500 ms.

14. A communication method of an ITU-T recommendation V.34 communication mode, comprising:
receiving a calling signal;
sending an ANSam signal; and
sending a DIS signal after a silent state from termination of sending the ANSam signal continues for a predetermined time.

15. The communication method according to claim 14, wherein the predetermined time is not less than 400 ms.

16. The communication method according to claim 15, wherein the predetermined time is not more than 500 ms.
